(19) United States
(12) Patent Application Publication
(10) Pub. No.: US 2015/0140423 A1
(43) Pub. Date: May 21, 2015

(54) COMPOSITE PARTICLE

(71) Applicant: Nexeon Limited, Abingdon (GB)

(72) Inventors: Scott Brown, Abingdon (GB); William James Macklin, Wantage (GB); Fazlil Coowar, Southampton (GB); Mamdouh Elsayed Abdelsalam, Southampton (GB)

(73) Assignee: Nexeon Limited, Abingdon (GB)

(21) Appl. No.: 14/403,932

(22) PCT Filed: May 24, 2013
(86) PCT No.: PCT/GB2013/051391

§ 371 Date: Nov. 25, 2014

(30) Foreign Application Priority Data
May 25, 2012 (GB) 1209250.8

(51) Int. Cl. H01M 4/60; H01M 4/62; H01M 4/583; H01M 4/1395; H01M 4/04; H01M 4/134; H01M 4/36; H01M 4/38

(52) U.S. Cl. CPC H01M 4/602; H01M 4/366; H01M 4/364; H01M 4/623; H01M 4/386; H01M 4/1395; H01M 4/0404; H01M 4/134; H01M 4/583; H01M 10/052
USPC 429/213; 427/58

(57) ABSTRACT

A composite particle for inclusion in a composite material of the sort used in electrochemical cells, metal ion batteries such as lithium-ion batteries, lithium air batteries, flow cell batteries, other energy storage devices such as fuel cells, thermal batteries, photovoltaic devices such as solar cells, filters and the like is provided. The composite particle comprises a particle core and a polymeric coating applied thereto. The present invention provides a composite material including a composite particle, methods of manufacturing both composite particles and composite materials and devices including such materials and particles.

### CROSS-REFERENCE TO RELATED APPLICATIONS

This application is a U.S. national application under U.S.C. 371 of PCT Application Number PCT/GB2013/051391, entitled “COMPOSITE PARTICLE”, filed on 24 May 2013 by NEXEON LIMITED, which claims priority of GB Patent Application Number 1209250.8, filed 25 May 2012, titled “COMPOSITE PARTICLE.” Each priority application listed herein is incorporated by reference in its entirety for all purposes.

### TECHNICAL FIELD

The present invention provides a composite particle for inclusion in a composite material of the sort used in electrochemical cells, metal ion batteries such as lithium-ion batteries, lithium air batteries, flow cell batteries, other energy storage devices such as fuel cells, thermal batteries, photovoltaic devices such as solar cells, filters, sensors, electrical and thermal capacitors, microfluidic devices, gas/vapour sensors, thermal or dielectric insulating devices, devices for controlling or modifying the transmission, absorption or reflectance of light or other forms of electromagnetic radiation, chromatography or wound dressings. Accordingly the present invention provides a composite material including a composite particle, methods of manufacturing both composite particles and composite materials and devices including such materials and particles.

### BACKGROUND

It should be appreciated that the term “particle” as used herein includes within its definition porous particles substantially as described in WO 2010/128310; porous particle fragments substantially as described in United Kingdom patent application number GB 1115262.6; particles including both branched and un-branched pillars extending from a particle core (hereafter referred to as pillared particles) substantially as described in US 2011/0067228, US 2011/0269019, US 2011/0250498 or prepared using the techniques described in U.S. Pat. No. 7,402,829, JP 2004281317, US 2010/0285358, US 2010/0297502, US 2008/0261112 or WO 2011/117436; fibres substantially as described in U.S. Pat. No. 8,101,298, where the fibres may be substantially solid or may include pores or voids distributed over the surface thereof; flakes and ribbons substantially as described in US 2010/0190061 (which also may be substantially solid or have pores or voids distributed over the surface thereof), fractals substantially as described in GB 1115262.6; substrate particles and scaffold structures substantially as described in US 2010/0297502; fibre bundles as described in PCT/GB2011/000856 and native particles or granules prepared by, for example, ball milling bulk metallurgic, solar or electronics grade silicon.

### BRIEF DESCRIPTION OF FIGURES

FIG. 1 is a graph illustrating a cycle-life of a half cell.

### DETAILED DESCRIPTION

The particles disclosed herein above are suitably defined in terms of their size and shape. Not all particles will be truly spherical and will generally be characterised by a principle or larger dimension (or diameter) and a minor (or smallest) dimension or diameter. For a spherical or substantially spherical particle the principle and minor dimensions will generally be the same or similar. For an elongate particle such as a fibre, however, the principle dimension will generally be defined in terms of the fibre length and the minor dimension will generally be defined in terms of the fibre thickness. The particles may also be defined in terms of their aspect ratio, which is the ratio of the magnitude of the principle dimension to that of the minor dimension.

Further the term “active particle” as used herein should be understood to mean a particle comprising a material, which possesses an inherent property (for example an electrical, electronic, electrochemical or optical property) whereby the operation of a device including that particle is dependent on its inherent property. For example, if the particle comprises a material that is inherently electroactive, that electroactivity can form the basis of a secondary battery including that particle. By the term “electroactive” it should be understood to mean a material which, when used in battery applications is able to insert into its structure, and release therefrom, metal ions such as ions of lithium, sodium, potassium, calcium or magnesium during the respective battery charging phase and discharging phases. Preferably the material is able to insert and release lithium. If the particle comprises a material which inherently exhibits photovoltaic activity, particles including such a photovoltaic material can be used in the formation of solar cells, for example. Further if the material is placed in an environment in which it naturally corrodes, the resulting corrosion current can be harnessed and the material can be used as a battery to power an external device; devices of this type are commonly known as “fuel cells” in which the corroding material provides the fuel. The operation of devices such as sensors, particularly silicon sensors depends on the induced changes in the resistivity or conductivity that arise as a result of the presence of sensed contaminants, for example, the inherent property of such devices being the resistivity or conductivity of the sensor material. For the purposes of the present invention, the term “active particle” should be understood to mean a particle that exhibits electroactive, photovoltaic and galvanic properties.

The term “composite particle” as used herein should be understood to mean a particle as described herein in which a coating material is provided on a particle core.

The term “composite material” should be understood to mean a material comprising a composite particle and one or more additional components selected from the group comprising a binder, a conductive material, a filler, a second active material or a mixture thereof. The second active material may be an electroactive material. Composite materials are generally formed by drying a slurry including the components described above to remove the slurry solvent.

The term “electrode material” should be understood to mean a composite material in which the composite particle and/or the other components of the composite material comprise an electroactive material.

The term “composite mix” should be understood to mean a composition comprising a slurry of a composite particle and one or more additional components selected from the group comprising a binder, a conductive material, a filler, an second active material or a mixture thereof in a liquid carrier. The second active material may be an electroactive material.

The term “electrode mix” should be understood to mean a composite mix in which the composite particle and/or the other components of the composite material comprises an electroactive material.

The term “stable suspension” should be understood to mean a dispersion of particles in a liquid carrier, wherein the particles do not or do not tend to form aggregates.

The term “coating polymer” and “polymeric coating” are used interchangeably throughout this application.

Active particles, such as those described above may be used in applications including electrochemical cells, metal ion batteries such as lithium-ion batteries, lithium air batteries, flow cell batteries, other energy storage devices such as fuel cells, thermal batteries, photovoltaic devices such as solar cells, filters, sensors, electrical and thermal capacitors, microfluidic devices, gas/vapour sensors, thermal or dielectric insulating devices, devices for controlling or modifying the transmission, absorption or reflectance of light or other forms of electromagnetic radiation, chromatography or wound dressings. U.S. Pat. No. 5,914,183 discloses a luminescent device comprising a wafer including quantum wires formed at the surface thereof.

Porous silicon particles may also be used for the storage, controlled delivery or timed release of ingredients or active agents in consumer care, nutritional or medical products. Examples of porous silicon particles of this type are disclosed in US 2010/0278931, US 2011/0236493, U.S. Pat. No. 7,332,339, US 2004/0052867, US 2007/0255198 and WO 2010/139987. These particles tend to be degraded or absorbed in the physiological environment of the body. Degradable or absorbable particles are inherently unsuitable for use in the applications described above.

Secondary batteries including composite electrodes comprising a layer of structured silicon particles on a current collector are known and are described in, for example: US20100112475, U.S. Pat. No. 4,002,541, U.S. Pat. No. 4,363,708, U.S. Pat. No. 7,851,086, US 2004/0214085, US 2009/0186267, US 2011/0067228, WO 2010/130975, WO 2010/1309766 and WO 2010/128310.

The preparation of composite materials of the type referred to herein is not always easy, especially where the composite material includes two or more active particle types. The cohesiveness of a composite particulate material including a binder strongly depends on the compatibility of the binder with the particles in that material. By the term “cohesion” is should be understood to mean the ability of one particle within a matrix to stick or adhere to (and remain stuck) to an adjacent particle and the term “cohesive” should be understood accordingly. For the avoidance of doubt, a binder is understood to be compatible with a particle if it is able to form a cohesive material with particles of that type and the term “compatible” should be understood accordingly; in other words a binder is compatible with a particle if it is able to stick or adhere to the particle and substantially remain so in use.

A binder, which can be used to prepare a highly cohesive material using a first type of active particle may not be compatible with a second type of particle and composite materials comprising that binder and the second type of particle may be poorly cohesive and prone to degradation in use. This is a particular problem for composite materials comprising a combination of first and second types of active particle having differing degrees of compatibility with the binder. Although the particle combination has the potential to enhance the capacity of the material above that comprising one type of electroactive particle only, if the binder is compatible with the first type of active particle and incompatible with the second type of active particle, the resulting composite material is typically characterised by poor cohesion due to the incompatibility of the second type of active particle with the binder. This means that a binder, which is compatible with and can successfully form a cohesive material with a first type of active particle may not always be compatible with a second active particle present in a composite material comprising the two particle types and although the composite material may have a better potential capacity, it tends to be poorly cohesive and may degrade in use. This problem has been particularly observed with carbon-based composite materials comprising metal or semi-metal additives such as silicon, which can be used in the preparation of, for example, lithium ion battery electrodes. Although it is possible to prepare a highly cohesive graphite-containing composite material using PVDF having no additional functional groups as a binder, this type of PVDF exhibits at the most only minimal adhesion to the surface of metal or semi-metal particles, such as silicon particles, and graphite-based composite materials including particle of a metal or a semi-metal such as silicon are characterised by reduced cohesion and a tendency to suffer degradation (structurally or of its performance characteristics) in use.

There is a need, therefore, for a composite material, which comprises a binder and particles of two or more different active materials, which composite material is highly cohesive and does not degrade in use. By the term “different” it is to be understood that the material comprising one type of particle is substantially incompatible with a binder used to bind particles of a second or subsequent particle type in a composite material. For example, there is a need for a highly cohesive graphite-based composite material which includes, in addition to particles of graphite, particles of a different material such as a metal or a semi-metal. There is a particular need for a highly cohesive composite material comprising particle of graphite and particle of silicon. The present invention addresses that need.

The present inventors have surprisingly found that highly cohesive composite materials comprising two or more types of active particle can be prepared by providing one type of particle in the form of a composite particle, which comprises a particle core and a first polymeric coating. The composite particle preferably, but not exclusively, comprises the minor component of a composite material comprising two or more types of active particle. The first polymeric coating comprises a polymer that is compatible with the material of the particle core. It has been surprisingly found that composite particles of the type defined herein are highly compatible with the polymeric binders used to bind the second and subsequent active particle components of the composite materials and facilitates the formation of a highly cohesive composite material. A first aspect of the invention provides an electrode for a lithium ion battery, the electrode comprising a current collector and a composite material applied to the surface of the current collector, wherein the composite material comprises an electroactive composite particle comprising:
a. a first particle component selected from the group comprising silicon, tin, germanium, gallium, lead, zinc, aluminium and bismuth and alloys and oxides thereof; and
b. a first polymeric coating
   characterised in that the first polymeric coating adheres to the surface of the first particle component, is insoluble in N-methyl pyrrolidone (NMP), comprises one or more functional groups selected from a carboxylic acid and sulphonic acid functional group and covers at least 70% of the surface area of the first particle component.

Optionally the first polymeric coating comprises a carboxylic acid functional group.

Optionally the first polymeric coating is selected from the group of polymers comprising polyacrylic acid, carboxymethyl cellulose, alginic acid, polyethylene maleic anhydride and a vinylsulphonic acid polymer.

Optionally the first polymeric coating is an alkali salt of the functional group, preferably a salt of sodium, potassium, lithium, calcium or magnesium, especially sodium.

Optionally the first particle component is silicon or an oxide thereof.

Optionally the first particle component has a principle diameter in the range 100 nm to 100 μm.

Optionally the first particle component has a minor diameter of at least 10 nm.

Optionally the first particle component has an aspect ratio (ratio of principle diameter to minor diameter) in the range 1:1 to 100:1.

Optionally the first particle component is selected from the group comprising native particles, pillared particles, porous particles, porous particle fragments, fractals, fibres, flakes, ribbons, tubes, fibre bundles, substrate particles and scaffold structures.

Optionally the first particle component is selected from doped and undoped silicon.

Optionally the first polymeric coating is porous.

Optionally the first polymeric coating comprises a polymer having a molecular weight in the range 100,000 to 3,000,000.

Optionally the first polymeric coating has a degree of salt formation of at least 60%, preferably in the range 60 to 100%.

Optionally the thickness of the first polymeric coating is in the range 5 to 40 nm.

Optionally the composite material further comprises a second active particle component and a polymeric binder. Optionally the second active particle component comprises an electroactive material. Optionally the second active particle comprises a second polymeric coating.

Optionally the composite material of the electrode comprises at least 50 wt % of an electroactive material comprising a first composite particle. Optionally the composite particle comprises at least 0.5 wt % of silicon.

Optionally the composite material comprises at least 5 wt % of an electroactive carbon.

Optionally the composite material further comprises a third conductive component.

Optionally the composite material comprises a first particle component having a first polymeric coating, a second particle component and a polymeric binder, wherein the first particle component, first polymeric coating, second particle component and polymeric binder are present in a weight ratio in the range 9.0:0.05:88:2.95 to 9.0:0.5:88:2.5.

Optionally the composite material further includes a third conductive component, wherein the first particle component, first polymeric coating, second particle component, polymeric binder and third conductive component are present in a weight ratio in the range 9.0:0.05:85:2.95:3 to 9.0:0.5:85:2.5:3.

Optionally the second coating polymer has a molecular weight in the range 100,000 to 3,000,000.

Optionally the second coating polymer comprises one or more functional groups selected from the group comprising a carboxylic acid and a sulphonic acid functional group or a sodium salt thereof.

Optionally the second coating polymer is selected from the group comprising polyacrylic acid, polyethylene maleic anhydride, alginic acid, carboxymethylcellulose, a vinyl sulphonic acid polymer and the sodium salts thereof.

Optionally the polymeric binder has a molecular weight in the range 100,000 to 3,000,000.

Optionally the polymeric binder has a molecular weight of 700,000.

Optionally the polymeric binder is an ionically conductive polymer or an electrically conductive polymer.

Optionally the polymeric binder has a Young's Modulus of at least of 0.3 GPa Optionally the polymeric binder is polyvinylidenefluoride (PVdF) or copolymers thereof. Optionally the PVdF comprises from 0.7 to 1.0 wt % functional co-monomer groups within its structure. Optionally the functional co-monomer groups comprise carboxylic acid monomer groups.

Optionally the electrode comprises a third conductive component selected from the group comprising carbon black, lamp black, acetylene black, ketjen black, metal fibres and mixtures thereof.

Optionally the second active particle component comprises graphite, hard carbon, graphene, carbon fibres, carbon nanotubes and mixtures thereof. Optionally graphite is selected from the group comprising natural graphite, artificial graphite and meso-carbon micro-beads and a mixture thereof.

Optionally the composite particle comprises a first particle component comprising silicon and a first polymeric coating selected from the group comprising sodium polyacrylate, sodium carboxymethylcellulose, sodium polyethylene maleic anhydride and sodium alginate.

Optionally the second particle component comprises graphite and the binder comprises PVdF. Optionally the PVdF comprises 0.7 to 1.0 wt % functional co-monomer groups within its structure.

The first particle component is suitably electroactive. Preferably an electroactive first particle component comprises silicon, a silicon alloy or oxides thereof.

The particles referred to herein are suitably defined in terms of their diameters. Both the first particle component and the composite particle will each be provided in the form of a sample comprising a plurality of particles comprising a distribution of the particle sizes. The particle size distribution may be measured by a technique such as laser diffraction, in which the particles being measured are typically assumed to be spherical, and in which particle size is expressed as a spherical equivalent volume diameter. An example of a particle size analyzer, which uses laser diffraction is the Mastersizer™ available from Malvern Instruments Ltd. A spherical equivalent volume diameter is the diameter of a sphere with the same volume as that of the particle being measured. If all particles in the powder being measured have the same density then the spherical equivalent volume diameter is equal to the spherical equivalent mass diameter which is the diameter of a sphere that has the same mass as the mass of the particle being measured. For measurement the powder is typically dispersed in a medium with a refractive index that is different to the refractive index of the powder material. A suitable dispersant for powders of the present invention is water. For a powder with different size dimensions such a particle size analyser provides a spherical equivalent volume diameter distribution curve.

Size distribution of particles in a powder measured in this way may be expressed as a diameter value Dn in which at least n % of the volume of the powder is formed from particles have a measured spherical equivalent volume diameter equal to or less than D. For example, a D₁₀ value (e.g 4 μm) means that 10% of particles in a sample have a spherical equivalent volume diameter of this value (e.g 4 μm) or less. Similarly the term D₅₀ means that 50% of the particles in a sample have a spherical equivalent volume diameter of this D₅₀ value or less. Finally the term D₉₀ means that 90% of the particles in a sample have a spherical equivalent volume diameter of this D₉₀ value or less. Where particle diameters are quoted herein, the quoted values should be understood to refer to D₅₀ values unless otherwise stated. The first particle component suitably has a principle diameter in the range 100 nm to 100 μm. Further, the first particle component has a minor dimension of at least 10 nm. In addition the first particle component is typically characterised by an aspect ratio in the range 1:1 to 100:1, for example 2:1.

The first particle component may comprise a structured particle or a native active particle as defined above. Examples of structured particles include, but are not limited to pillared particles, porous particles, porous particle fragments to include fractals, fibres (to include threads, wires, nano-wires, pillars), flakes, ribbons, scaffold structures, fibre bundles, substrate particles (nano-particles of metal or a semi-metal such as silicon on a larger carbon particle substrate), tubes and nano-tubes. These structures are defined in US 2013/0069601, the contents of which are incorporated herein by reference. Preferably the first particle component comprises silicon. The silicon-comprising first particle component may comprise a doped or an un-doped silicon material. Doped silicon materials include n-type and p-type doped materials in which the silicon is doped with elements such as phosphorous or boron respectively. The silicon material preferably has silicon purity in the range 90.00 wt % to 99.995 wt %, preferably 95 to 99.99 wt % and especially 98.00% to 99.95 wt %. Preferably the silicon material comprises metallurgical grade silicon.

In a first embodiment of the first aspect of the invention, the electrode comprises a first particle component comprising silicon fibres having a diameter in the range 10 to 1000 nm. The fibres suitably have a length in the range 0.5 to 100 μm. Preferably the fibres have an aspect ratio in the range 5:1 to 1000:1. In a second embodiment of the first aspect of the invention, the first particle component comprises silicon pillared particles having a d₅₀ value of from 4 μm to 5 μm, a d₁₀ value of from 2 to 3 μm and a d₉₀ value of from 7 To 8 μm.

In a third embodiment of the first aspect of the invention, the electrode comprises a first particle component comprising silicon native particles having a d₅₀ value of from 4.4 to 4.8 μm, a d₁₀ value of from 2.2 to 2.3 μm and a d₉₀ value of from 8 to 9 μm.

The coating polymers preferably include functional groups within their structure, which react with complementary functional groups on the surface of the metal or semi-metal of the first particle component. Preferably the first particle component comprises a silicon particle. Preferably, the first coating polymer comprises functional groups, which react with hydroxyl (OH) groups on the surface of the silicon particle. Examples of polymer based functional groups, which react with complementary (usually OH) functional groups on the surface of a metal or semi-metal particle (such as a silicon particle) include carboxylic acid and sulphonic acid groups. Carboxylic acid groups are preferred.

The first polymeric coating may optionally include conductive components such as a metal or a conductive carbon. Examples of carbon based conductive components include carbon black, acetylene black, ketjen black, lamp black, vapour grown carbon fibres (VGCF), carbon nanotubes (CNT), graphene and hard carbon. Preferably the first polymeric coating comprises a carbon nano-tube as its conductive carbon.

The first polymeric coating is suitably soluble in a solvent used to support the process of coating silicon particles. Suitably the solubility of the polymeric coating in its chosen solvent is greater than 0.1 wt %, preferably greater than 0.5 wt %. Preferably the first polymeric coating is soluble in water and insoluble in NMP or other solvents used to prepare composite materials.

Where a coating polymer includes a carboxylic acid or sulphonic acid based functional groups within its structure, these functional groups may suitably be fully or partially neutralised by reaction with sodium to form the sodium salt of the corresponding acid functionalised polymer. Preferably the polymer includes one or more carboxylic acid groups as functional groups. Reaction of the acid based polymer with a sodium base salt results in the formation of a sodium salt of the carboxylic acid, which is also known as sodium carboxylate. At least 40% and preferably 50 to 100% of the carboxylic acid groups in the polyacrylic acid may be neutralised through reaction with sodium and the resulting polymer salt can thus be defined in terms of either its degree of neutralisation or degree of salt formation. Suitably the functionalised polymer is neutralised using sodium hydroxide or sodium carbonate The desired degree of neutralisation will depend upon the extent to which the resulting polymeric sodium salt is soluble in NMP. Preferably, the neutralised or partially neutralised polymeric sodium salt should be insoluble in NMP. Preferably the neutralised or partially neutralised polymeric sodium salt should be soluble in water. It has been found, for example, that a polymeric carboxylic acid sodium salt having a degree of neutralisation of more than 40% or in the range 50 to 100% is soluble in water and is insoluble in NMP.

The term soluble when used in the context of the present invention means that the coating polymer has a solubility of at least 0.1% in a chosen solvent. Preferably the coating polymer has a solubility of between 0.1 and 40% in a chosen solvent. Preferably the chosen solvent is water. Preferably the first coating polymer is sodium polyacrylate having a degree of neutralisation of at least 40%, more preferably at least 50% and especially between 60 and 100% and the solvent is water. The solubility of a sodium polyacrylate polymer depends on the molecular weight of the polymer. For example, it is possible to prepare a solution comprising 15 wt % of a sodium polyacrylate polymer having a molecular weight of 450K. However, it is not possible to prepare a solution comprising more than 2 wt % of sodium polyacrylate polymer having a molecular weight of 3,000,000. The term insoluble in NMP when used in the context of the present invention means that it is not possible to prepare solutions comprising more than 0.1 wt % of the coating polymer, preferably not more than 0.01 wt %.

Examples of suitable first coating polymers include homo-polymers and copolymers of polyacrylic acid (PAA), polyethylene maleic anhydride (PEMA), carboxymethyl cellulose (CMC), alginic acid, amylose, amylopectin, poly-γ-glutamic acid vinyl sulphonic acids and sodium salts thereof.

Preferably the coating polymer comprises sodium polyacrylate having a degree of neutralisation of at least 40%, more preferably at least 50% and especially in the range 60 and 100%.

The first coating polymer suitably has a molecular weight (weight average molecular weight) in the range 100,000 to 3,000,000, preferably 250,000 to 2,000,000, more preferably 450,000 to 1,000,000. Composite materials including composite particles of the first aspect of the invention including a coating having a molecular weight of 3,000,000 have been prepared and have been found to exhibit good stability when included in an electrode of a lithium ion battery.

The first polymeric coating can be applied to the first particle component to a thickness of at least 5 nm. The first polymeric coating thickness may be between 5 and 40 nm, preferably 10 to 30 nm, more preferably 15 to 25 nm and especially 20 nm. The coating can be porous or non-porous. Preferably the first polymeric coating is porous with at least 5% porosity.

The first coating polymer sticks or adheres to the surface of the first particle component and this adhesion is substantially maintained both on inclusion of the composite particle in a composite material and during subsequent use of the composite material in, for example, a battery application. Preferably the first particle component is a metal or a semi-metal of the type referred to above. More preferably the first particle component is silicon or a silicon comprising material. Preferably the silicon-comprising particle is selected from the group comprising a silicon comprising fibre, silicon-comprising native particle, a silicon-comprising porous particle and a silicon comprising pillared particle. Porous particles, porous particle fragments, ribbons, flakes and tubes can all be used. The first coating polymer is compatible with NMP soluble binders, preferably PVDF based binders and is also able to form a cohesive composite material comprising a second active particle component, a composite particle according to the first aspect of the invention and an NMP soluble binder such as a PVDF binder. Preferably the second active particle component is a carbon based material such as graphite. Preferably the composite particle comprises silicon as a first particle component and a sodium polyacrylate coating. Preferably the composite particle comprises a structured silicon particle selected from the group comprising a silicon comprising fibre, silicon-comprising native particle, a silicon-comprising porous particle, a silicon porous particle fragment, a silicon flake, a silicon tube, a silicon ribbon and a silicon comprising pillared particle and a sodium polyacrylate coating. The polymeric coating of the composite particle may also include a conductive material within its structure. Examples of suitable conductive materials for inclusion in the first polymeric coating include carbon black, acetylene black, ketjen black, lamp black, vapour grown carbon fibres (VGCF), carbon nanotubes (CNT), graphene and hard carbon. Without wishing to be constrained by theory, it is believed that it is this cohesiveness between the first coating polymer and the binder of the composite material, preferably the PVDF binder, which surprisingly facilitates the preparation of highly cohesive composite materials, which include as an additive a metal or semi-metal additive. Preferably the composite material is a carbon-based composite material. Preferably the metal or semi-metal additive comprises silicon.

By the term “adhesive” it is to be understood to mean the ability of a coating to stick to a substrate. This covers on the microscopic scale, the ability of a coating polymer to stick to a substrate comprising a first particle component. On the macroscopic level, the term covers the ability of the composite material to stick to an underlying substrate, such as a copper current collector. The strength of adhesion will be understood to mean a measure of the force that needs to be applied to the coating in order to remove it from the underlying substrate. The adherency or strength of adhesion can be measured on a macroscopic scale using the Peel Test method, which is known a person skilled in the art.

The silicon-based composite particles included in the composite material of the electrodes of the present invention have been observed to cohere with the particles of the PVDF binder used in the preparation of a graphite-based composite material to give a coated silicon-graphite based composite material characterised by an improved cycle life when used, for example, in lithium ion battery applications compared to uncoated silicon-graphite composite materials. Half cells including graphite based anodes comprising uncoated silicon species exhibit a capacity loss of almost 100% over 30 cycles. Half cells including graphite based anodes comprising a sodium polyacrylate coated silicon particle (in which the coating has a molecular weight of 450,000 or 3,000,000) exhibit a capacity retention of approximately 75% to 80% over 80 cycles.

In addition to the composite particles described herein above, the composite materials of the electrode of the first aspect of the invention suitably further comprise a second active particle component and a polymeric binder, wherein the polymeric binder:
i. forms a cohesive material with the second active particle component and the composite particle;
ii. forms a non-cohesive material with the first particle component; and
iii. is soluble in N-methyl pyrrolidone and insoluble in water.

The second active particle suitably comprises an electroactive material, preferably an electroactive carbon, selected from the group comprising graphite, hard carbon, graphene, carbon nano-tubes, carbon fibres and mixtures thereof. Examples of graphite include particles and flakes of natural and artificial graphite including but not limited to meso-carbon micro-beads and massive artificial graphite. Examples of carbon fibres include vapour grown carbon fibres and meso-phase pitch based carbon fibres. Examples of carbon flakes include those sold by TIMCAL™ under the product name SFG6.

The second particle component may include a second polymeric coating. The second polymeric coating adheres to the surface of the second particle component. The second polymeric coating may be identical or different to the first polymeric coating applied to the first particle component. The second polymeric coating material is suitably an ionic or an electrically conducting polymer. The second polymeric coating material is suitably insoluble in N-methyl pyrrolidone. Suitably the second polymeric coating material has a weight average molecular weight in the range 100,000 to 3,000,000, preferably 450,000 to 2,500,000, especially 450,000 to 1,000,000. The second polymeric coating material may comprise (as part of its structure) functional groups, which react either with functional groups on the surface of the second particle component or with functional groups present in the structure of the first polymeric coating material. mPa·s. The second polymeric coating material can be applied to the surface of the second particle component to a thickness in the range of 2 to 40 nm, preferably 5 to 30 nm, especially 10 to 20 nm. Preferably the first coating material is different to the second coating material.

The polymeric binder is suitably soluble in N-methyl pyrrolidone (NMP). The polymeric binder may also include an electrically conductive or an ionically conductive component. The polymeric binder adheres to the second particle component or, where the second particle component also includes a second polymeric coating, the polymeric binder adheres to the second polymeric coating. The polymeric binder also adheres to the composite particle of the first aspect of the invention. The polymeric binder has a Young's Modulus of at least 0.3 GPa. Suitably the polymeric binder has a weight average molecular weight in the range 100,000 to 3,000,000, preferably 250,000 to 2,500,000 and especially 450,000 to 1,500,000. Examples of polymeric materials suitable for use as a polymeric binder include Polyvinylidene fluoride (PVdF) and grafted copolymers of PVdF. The use of PVDF 9400 is particularly preferred; this is comprises 0.7 to 1.0 wt % of a carboxylic acid functionalised co-monomer. These polymers are marketed as KF polymer by Kureha of Japan or Solvay of Belgium.

Ionically or electrically conductive polymers may also be used as polymeric binders. These include polypyrrole and polyimides.

The composite material included in the electrodes of the first aspect of the invention may, optionally, include a conductive component. Examples of conductive components include conductive carbon materials, metal particles, metal fibres and particles and fibres of a conductive ceramic. Preferably the conductive components include conductive carbon materials. Examples of suitable conductive carbons include but are not limited to carbon black, lamp black, acetylene black, ketjen black, super-P, channel black, carbon fibres, carbon nano-tubes and mixtures thereof.

The electrode according to the first aspect of the invention suitably comprises a composite material comprising at least 50 wt % of an electroactive material, preferably at least 60 wt % and especially at least 80 wt %. Preferably the composite materials comprise 50 to 98 wt % of an electroactive material. Preferably the electroactive material of the composite comprises at least 0.5 wt % of silicon. Preferably the electroactive material comprises at least 5 wt % of an electroactive carbon of the type specified herein above.

The relative amounts of the first particle component, second particle component, first polymer coating, polymer binder and optionally conductive material has been found to influence both the capacity and cycle life of a device including an electrode according to the first aspect of the invention, particularly an electrode for a battery. Where the electrode comprises a carbon based composite material, the first particle component is generally present in the form of an additive. In a preferred embodiment of the first aspect of the invention, the composite material comprises an electroactive material comprising carbon and silicon as an additive, wherein the silicon additive comprises at least 1 wt % of the electroactive material, preferably at least 2 wt %, more preferably at least 5 wt % and especially at least 10 wt %. Where silicon is present as an additive, the electroactive material suitably comprises not more than 50 wt % silicon, preferably not more than 40 wt % silicon and preferably not more than 20 wt % silicon. Where the composite material comprises silicon as an additive, the ratio of silicon to electroactive carbon is in the range 1:99 to 1:1, preferably 2:98 to 4:6, especially 10:90 to 20:80. In an especially preferred embodiment of the first aspect of the invention, the composite material comprises a second particle component, a first particle component, a first polymer coating and a polymer binder in the ratio 88:9:0.05:2.95 to 88:9:0.5:2.5. Where the composite material of the electrode includes a conductive material the second particle component, first particle component, first polymer coating, polymeric binder and conductive material are suitably present in a ratio of 85:9:0.05:2.9:3 to 85:9:0.5:2.5:3. As indicated above, the second particle component is preferably an electroactive carbon of the type referred to herein above. The conductive material may be included in the composite particle as part of the first polymer coating, as part of the composite material only or both within the composite particle and as part of the composite material. Preferably the second particle component comprises particles or flakes of a natural or an artificial graphite, preferably spherical synthetic graphite in the form of mesocarbon microbeads. Preferably the composite particle comprises a silicon particle having a sodium polyacrylate coating with a degree of neutralisation in the range 60 to 100%. Preferably the silicon particle is a silicon comprising fibre or a silicon comprising pillared particle. The composite material suitably comprises 2 to 15 wt % of the polymeric binder, preferably 2 to 10 wt %. Preferably the polymeric binder is PVdF, especially PVDF 9400. The composite material suitably comprises up to 10 wt % of the composite particle, preferably 4 to 8 wt %. Preferably the composite material includes vapour grown carbon fibres (VGCF) and/or carbon nano-tubes as a conductive material. In a most preferred embodiment of the first aspect of the invention, the electrode comprises a composite material comprising 85 to 88% by weight of a natural or an artificial graphite, 9% by weight of a silicon particle, 0.05 to 0.5% by weight of sodium polyacrylate having a degree of neutralisation in the range 60 to 100%, 2.5 to 2.95% by weight of a PVdF polymer binder and 0 to 3% of VGCF conductive carbon.

In an alternative embodiment of the first aspect of the invention, the electrode comprises a composite material comprising at least 50 wt % of a composite particle according to the first aspect of the invention, up to 40 wt % of an electroactive carbon and up to 10 wt % of a binder.

The composite materials included in the electrodes of the first aspect of the invention are cohesive materials, which adhere well to current collectors onto which they are formed. The electrodes of the first aspect of the invention may be simply prepared and a second aspect of the invention provides a method of manufacturing an electrode comprising a composite material, the method comprising the steps of preparing a slurry comprising a composite particle, a second particle component a polymeric binder and a carrier solvent and casting the slurry onto a current collector. The slurry is cast onto the current collector using known techniques such as dip coating, spin coating, spray coating and fluidised bed coating. The cast slurry is preferably dried to remove the carrier liquid. The polymeric binder may be provided in the form of a solution in the carrier liquid or in the form of particles suspended therein. Preferably the polymeric binder is soluble in the liquid carrier. More preferably the liquid carrier comprises a 0.1-5 wt. % solution of the polymeric binder. These composite particles can be easily prepared by adapting methods known to a person skilled in the art. A second aspect of the invention provides a method of making an electrode according to the first aspect of the invention, the method comprising the steps of forming a composite particle and depositing the composite particle onto the surface of a current collector, wherein formation of the composite particle comprises the steps of exposing a first particle component to a first coating polymer and isolating the coated particles.

Optionally the first coating polymer is provided in the form of a solution.

Optionally the method of the second aspect of the invention further includes the steps of drying the isolated coated particles.

Optionally the first coating polymer solution used in the method of the second aspect of the invention has a concentration in the range 5 to 25 wt %. Optionally the first coating polymer solution comprises a polymer having a weight average molecular weight in the range 100,000 to 3,000,000. Optionally the first coating polymer solution has a viscosity in the range 40 to 60 mPa·s.

Optionally the first coating polymer solution used in the method of the second aspect of the invention comprises a first and second solvent component, wherein:
a. the volume ratio of the first solvent component to the second solvent component is in the range 19:2 to 1:1;
b. the first coating polymer is soluble in the first solvent component;
c. the first coating polymer is insoluble in the second solvent component;
d. the second solvent component has a higher boiling point than that of the first solvent component.

Optionally the second solvent component used in the method according to the second aspect of the invention is removed thereby forming a composite particle comprising a porous coat, which porous coat covers at least 70% of the surface area of the first particle component. Optionally the coated particles are dried using one or more techniques selected from tray drying, spray drying, oven drying, fluidised bed drying and roll drying.

Optionally the method according to the second aspect of the invention further comprises the step of forming a slurry comprising the composite particle, a second active particle component and a polymeric binder in a liquid carrier, casting the slurry onto a current collector and drying the cast slurry. Optionally the liquid carrier comprises a solution of the polymeric binder.

Where composite particles are prepared in accordance with the method of the second aspect of the invention, these suitably have a moisture content of less than 20 ppm.

The first coating polymer is suitably soluble in water and insoluble in NMP. Preferably the first coating polymer is provided in the form of a sodium salt as this improves its solubility in water. It will be appreciated that the degree of polymer salt formation affects its water solubility and must be sufficient to provide a water solubility of 10 to 400 g/l, preferably 20 to 250 g/l, especially 50 to 150 g/l. The degree of salt formation necessary to achieve a water solubility in this range will depend on factors such as the polymer structure and its molecular weight. Typically the first polymer coating will have a degree of salt formation of at least 60%, preferably in the range 60 to 100% in order to achieve adequate solubility in water.

The first coating polymer is suitably prepared by neutralising the functionalised parent polymer prior to use: this is suitably achieved by mixing the functionalised polymer with an aqueous solution of sodium hydroxide or sodium carbonate. The degree of neutralisation can be readily controlled by varying the stoichiometric amounts of polymer and base. Such methods are known to a person skilled in the art. Preferably the functionalised polymer contains carboxylic acid as a functional group, which is neutralised using either sodium hydroxide or sodium carbonate to give sodium polyacrylate having a degree of neutralisation in the range 60 to 100%. Sodium polyacrylate having a degree of neutralisation of 100% can be prepared by mixing polyacrylic acid and sodium hydroxide in a 1:1 molar ratio. Sodium polyacrylate having a degree of neutralisation of greater than 100% can be formed in a similar way.

A solution of the first coating polymer in water is suitably used to coat the surface of the first particle component. The strength of the first coating polymer solution will depend, in part, upon the required silicon loading during the coating procedure, the particle size and the solubility of the first coating polymer in water. Suitably, first coating polymer solutions having strengths of between 0.1 and 40 wt %, preferably between 0.1 and 25 wt %, more preferably between 0.1 and 15 wt % can be used to coat the first particle component. Preferably, the strength of the polymer solution is less than 2 wt %, more preferably less than 1 wt. % and especially less than 0.5 wt %. The first coating polymer solution suitably has a viscosity no greater than 60 mPa·s, preferably no greater than 50 mPa·s. Preferably silicon is added to the solution of the first coating polymer to give a silicon loading in the range 2 to 20 wt %, preferably 10 wt %.

The surface of the first particle component may be treated before exposure to the coating solution in order to improve the adherency of the coating polymer to the particle surface. The silicon surface can be treated with a base to form hydroxyl groups on the surface of the first particle component. These hydroxyl groups react with functional groups on the first coating polymer to bind them to the surface of the first particle component. Where the first particle component comprises silicon, this is suitably washed with a solution of an alkali to increase the number of surface groups with which an acid functionalised first coating polymer reacts. Treatment of the silicon surface with acids such as oxalix acid or a mineral acid prior to coating the silicon particle may also be possible too.

Suitable methods that can be used to expose the first particle component to a solution of the first coating polymer include dip coating, spray coating, chemical vapour deposition and fluidised bed coating methods. Preferably the composite particles of the first aspect of the invention are prepared using a dip coating technique and in a first preferred embodiment the composite particles are prepared using a dip-coating method, which comprises the steps of exposing particles of a first particle component to an aqueous solution of a first coating polymer for a period of between 10 minutes and 2 hours, preferably between 30 minutes and one hour, more preferably between 45 minutes and one hour and especially one hour, removing the coated particles from the solution and drying the coated particles. The temperature of the first coating polymer solution can be adjusted in order to provide a coating solution of a suitable viscosity. Preferably, however, the coating of the silicon particles is carried out at room temperature.

Preferably the coating procedure is carried out at room temperature. Any suitable method can be used to dry the resulting composite particles. Preferably the particles are dried using a dynamic vacuum. The mass per unit volume (of solution) of silicon to be coated (silicon loading) depends on both the size of the particles to be coated and the strength of the coating polymer solution. Preferably the particle loading and the strength of the coating solution are adjusted to give a particle:coating polymer ratio in the range 9:0.5 to 9:0.05, preferably 9:0.3 to 9:0.1. he coating procedure is suitably carried out at room temperature. The first particle component may be surface treated prior to the coating procedure as described herein above to enhance the strength of adhesion between the coating polymer and the particle surface.

In a second preferred embodiment the method comprises exposing silicon particles at room temperature to a solution of sodium polyacrylate having a degree of neutralisation of 100% for one hour, removing the coated particles from the solution and drying the particles under a dynamic vacuum, wherein the ratio of silicon particles:sodium polyacrylate is in the range 9:0.5.

As indicated above, composite particles comprising a porous coating can be included in the electrodes of the first aspect of the invention. These can be prepared using a phase inversion technique and a third preferred embodiment of the second aspect of the invention provides a method in which the composite particles are prepared by exposing silicon particles to a coating polymer solution comprising first and second solvent components, wherein:
i. the volume ratio of the first solvent component to the second solvent component is in the range 19:2 to 1:1;
ii. the coating polymer is soluble in the first solvent component;
iii. the coating polymer is insoluble in the second solvent component; and
iv. the second solvent component has a higher boiling point that the first solvent component.

Removal of the first solvent component from the coated particle mixture results in the formation of a polymer coating including the second solvent component. This can be achieved by drying the coated product at a temperature at or above the boiling point of the first solvent component but below that of the second solvent component. The second solvent component can be removed from the polymer coating by raising the drying temperature to a temperature at or above the boiling point of the second solvent component to give a porous polymer coating. The two stage drying process can be carried out using techniques that are well known to a person skilled in the art. Such techniques include oven or tray drying, spray drying, fluidised bed drying and roll drying.

Suitably the slurry has a solids content (including polymeric binder) in the range 30 to 60 wt %. Preferably the slurry has a viscosity in the range 1000 to 4000 mPa·s as measured at 20 s⁻¹ shear rate. The slurry is suitably prepared at room temperature. Preferably the slurry is subjected to shear mixing to disperse the de-agglomerated solids in the liquid carrier.

The slurry is suitably cast onto a current collector to a thickness of between 30 and 60 μm, preferably between 35 and 50 μm, more preferably between 25 and 40 μm, especially 37 μm and dried to give a coating having a coating weight in the range 30 to 70 gsm, preferably 40 to 60 gsm, especially 60 gsm.

Once cast, the electrode coating is typically dried under dynamic vacuum conditions at a temperature of between 130 and 170° C., preferably 150° C. for between 6 and 15 hours, preferably 10 hours to give a composite material having a residual liquid carrier content of no more than 20 ppm.

The second particle component may be treated prior to formation of the slurry to enhance the adhesion of the polymeric binder thereto. Suitable treatments include forming acid, alkali or other functional groups on the surface of the second particle component, which react with functional groups comprised within the polymeric binder to form strong bonds between the polymeric binder and the surface of the second particle component. Where the second particle component comprises a second polymeric coating, the second polymeric coating may include within its structure functional groups, which react with functional groups comprised within the structure of the polymeric binder.

The substrate onto which the slurry is cast may be electrically conductive or non-conductive in nature. Preferably the substrate is electrically conductive. The electrically conductive substrate is suitably a current collector selected from the group comprising copper, steel and aluminium foils. Preferably the substrate is a copper foil. Preferably the copper foil has a thickness of 10 to 15 μm, preferably 10 μm. A copper foil current collector may be treated with zirconia to increase the tensile strength of the substrate. Alternatively or in addition a copper foil current collector may be roughened to increase the adherence of a composite material thereto.

In addition to its use as a cell or battery electrode, the composite material of the electrode may be included as a component in a number of devices including a battery such as a lithium ion battery or a lithium air battery, a capacitor, a chemical or biological sensor and a solar device. A third aspect of the invention provides a cell or battery comprising an electrode according to the first aspect of the invention. Preferably, the electrode is an electrode for a lithium ion battery, preferably an anode. A fourth aspect of the invention provides a device comprising an electrode according to the first aspect of the invention. Examples of devices comprising the electrodes of the first aspect of the invention include batteries including secondary batteries and lithium air batteries, capacitors, sensors and solar cells.

In a preferred embodiment of the fourth aspect of the invention there is provided a lithium ion battery comprising an anode, a cathode and an electrolyte, wherein the anode comprises composite particles or composite materials disclosed herein. Preferably the lithium ion battery anode comprises an anode composite comprising a composite particle comprising a silicon comprising first particle component having a sodium polyacrylate coating, a graphite, PVdF binder and a carbon mix comprising vapour grown carbon fibres (VGCF), carbon nano-tubes (CNT) and ketjen black EC600 in a 5:5:2 ratio. Preferably the composite particle, graphite, PVdF and conductive carbon are present in a ratio of 9.5:85:2.5:3. Preferably the silicon comprising first particle component comprises 9 parts by weight of the anode composite. Preferably the silicon comprising first particle component comprises a silicon fibre or a silicon pillared particle. Preferably the sodium polyacrylate coating comprises 100% neutralised sodium polyacrylate. The composite is formed into a slurry and cast as a layer onto a 10 μm thick copper foil to give a 1.5 g/cc coating.

Examples of cathode active materials that can be used together with the anode active materials of the present invention include, but are not limited to, layered compounds such as lithium cobalt oxide, lithium nickel oxide or compounds substituted with one or more transition metals such as lithium manganese oxides, lithium copper oxides and lithium vanadium oxides. Examples of suitable cathode materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂, Li₂FeSiO₄, LiFePO₄, S and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

The electrolyte is suitably a non-aqueous electrolyte containing a lithium salt and may include, without limitation, non-aqueous electrolytic solutions, solid electrolytes and inorganic solid electrolytes. Examples of non-aqueous electrolyte solutions that can be used include non-protic organic solvents such as N-methylpyrrolidone, propylene carbonate, ethylene carbonate, butylenes carbonate, dimethyl carbonate, diethyl carbonate, gamma butyro lactone, 1,2-dimethoxy ethane, 2-methyl tetrahydrofuran, dimethylsulphoxide, 1,3-dioxolane, formamide, dimethylformamide, acetonitrile, nitromethane, methylformate, methyl acetate, phosphoric acid trimester, trimethoxy methane, sulpholane, methyl sulpholane and 1,3-dimethyl-2-imidazolidione.

Examples of organic solid electrolytes include polyethylene derivatives polyethyleneoxide derivatives, polypropylene oxide derivatives, phosphoric acid ester polymers, polyester sulphide, polyvinyl alcohols, polyvinylidine fluoride and polymers containing ionic dissociation groups.

Examples of inorganic solid electrolytes include nitrides, halides and sulphides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiB₁₀C₂₀, LiPF₆, LiCF₃SO₃, LiAsF₆, LiSbF₆, LiAlCl₄, CH₃SO₃Li and CF₃SO₃Li.

Where the electrolyte is a non-aqueous organic solution, the battery is provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene films.

The battery according to the fourth aspect of the invention can be used to drive a device, which relies on battery power for its operation. Such devices include mobile phones, laptop computers, GPS devices, motor vehicles and the like. A fifth aspect of the invention therefore includes a device including a battery according to the fourth aspect of the invention.

It will also be appreciated that the invention can also be used in the manufacture of solar cells, fuel cells and the like.

On formation of a composite particle used in the electrode of the first aspect of the invention, the reactivity of the surface of the first particle component is significantly reduced relative to its reactivity in air, for example. It will therefore be appreciated that the long term stability of the first particle component in air is significantly enhanced through the formation of a composite particle. Metals and semi-metals as defined herein above can therefore be readily stored through the formation of a composite particle. An sixth aspect of the invention provides a method of storing a first particle component comprising a metal or a semi-metal selected from but not limited to the group comprising silicon, tin, germanium, gallium, lead, zinc, aluminium and bismuth, the method comprising forming a composite particle according to the first aspect of the invention.

The invention will now be described with reference to the following non-limiting figures and examples set out herein below. Variations on the examples falling within the scope of the claims will be apparent to a person skilled in the art.

### FIGURES

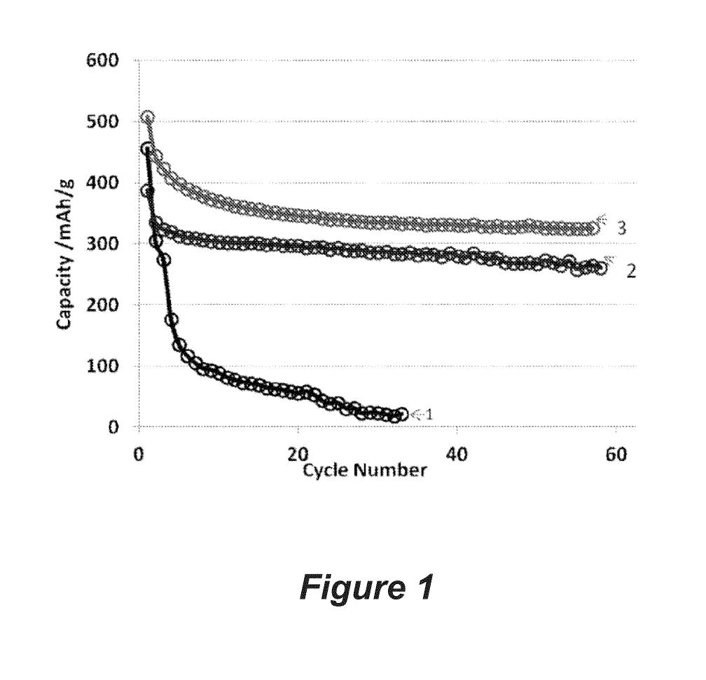

FIG. 1 is a graph illustrating how the capacity (mAh/g) of a Swagelock® half cell comprising a composite anode comprising a mixture of graphite and silicon native particles (d₅₀=4.7 μm, Sold as Silgrain® by Elkem of Norway) changes with cycle number. On the formation the cell was charged for one cycle at C/25 and discharged to between 1.0 and 0.005V. Thereafter it was either charged at C/5 at constant voltage conditions for 2 hours or under a constant current charging rate at C/20. It was discharged at C/5. The anode of Cell 1 comprises silicon native particles (9 parts), graphite (MCMB) (85 parts), VGCF conductive carbon (3 parts) and PVDF (9400) as a binder (3 parts). The anode of Cell 2 comprises silicon native particles (9 parts), graphite (MCMB) (85 parts), sodium polyacrylate (MW=450,000) having a degree of neutralisation of 100% (0.2 parts), PVDF (9400) binder (2.8 parts) and VGCF conductive carbon (3 parts). The anode of Cell 3 comprises silicon native particles (9 parts), graphite (MCMB) (85 parts), sodium polyacrylate (MW=3,000,000) having a degree of neutralisation of 100% (0.2 parts), VGCF conductive carbon (3 parts) and PVDF (9400) as a binder (2.8 parts). All cells comprise a lithium cathode, a Tonen® polyethylene separator and an electrolyte comprising a solution of LiPF₆ (1.2M) in a solution comprising 82% of a 1:3 mixture of ethylene carbonate and ethylmethylcarbonate, 15% fluoroethylene carbonate and 3 wt % vinylcarbonate.

### EXAMPLES

### Example 1

### Formation of a Silicon-Sodium Polyacrylate Composite Native Particle

### Example 1 a

Polyacrylic acid (2.22 g, MW=3,000,000) was mixed with sodium hydroxide in 1 litre of water. The concentration of the sodium hydroxide solution in water was 1.23 g in 1 litre. The molar ratio of the polyacrylic acid to the sodium hydroxide was 1:1. The resulting mixture was stirred until a clear solution was obtained. The final solution contained 0.22 wt % sodium polyacrylate in which 100% of the carboxylic acid groups have been neutralised, the solution having a viscosity of the order of 50 mPa·s.

50 g of native silicon particles (Silgrain HQ® from Elkem® of Norway, d₅₀=4.7 μm as measured using a Malvern Master Sizer® having a silicon purity in the range 99.7-99.9 wt %, most typically around 99.8 wt %. Impurities include Al, Ca, Fe and Ti. The aluminium impurities mean that it is p-type doped) were dispersed in (500 g) of the sodium polyacrylate solution using the IKA Eurostar® overhead mixer for 1 hour. The water was evaporated using a hot plate at 150° C. to produce NaPAA coated silicon. Finally the coated silicon was dried under dynamic vacuum conditions at 80° C. for 5 hours to give silicon particles having a sodium polyacrylate coating.

### Example 1 b

The same procedure was followed as in Example 1a above, but sodium polyacrylate (MW=450,000) was used instead of sodium polyacrylate (MW=3,000,000).

### Example 2a

### Preparation of a Silicon Native Particle-Graphite Composite Material Comprising a Conductive Carbon

A slurry was formed by shear mixing 85 parts by weight spherical synthetic graphite (d₅₀=27 μm), 3 parts by weight of VGCF, 9 parts by weight of a silicon native particle (d₅₀=4.7 μm, uncoated, as specified in Example 1) and 3 parts by weight of a PVdF (9200) binder in NMP as the carrier liquid using a T25 IKA High Shear Mixer®. The final solids content of the slurry is in the range 30 to 50%. The viscosity of the slurry is in the range 1-000 to 4500 mPa·s. The resulting slurry was cast onto a copper foil to a thickness of 60 g/cm².

### Example 3

### Preparation of a Silicon Native Particle-Graphite Composite Material Comprising a Conductive Carbon

### Example 3a

A slurry was formed by shear mixing 85 parts by weight of spherical synthetic graphite (d₅₀=27 μm), 3 parts by weight of VGCF, 9.2 parts by weight of a composite silicon native particle (9 parts silicon particle as specified in Example 1 and 0.2 parts sodium polyacrylate, MW=3,000,000), and 2.8 parts by weight of a PVdF (9200) binder in NMP as the carrier liquid using a T25 IKA High Shear Mixer®. The final solids content of the slurry is in the range 30 to 50%. The viscosity of the slurry is in the range 1000 to 4500 mPa·s. The resulting slurry was cast onto a copper foil to a thickness of 60 g/cm².

### Example 3b

The procedure was repeated using sodium polyacrylate having a molecular weight of MW=450,000 instead of MW=3,000,000 to give a composite having sodium polyacrylate (MW=450,000) coated silicon particles.

### Example 4

### Preparation of Cells

### Electrode and Cell Fabrication

### Anode Preparation

The desired amount of composite particle was added to a carbon mixture that had been bead milled in deionised water as specified above. The resulting mixture was then processed using a T25 IKA High Shear® overhead mixer at 1200 rpm for around 3 hours. To this mixture, the desired amount of binder in solvent or water was added. The overall mix was finally processed using a Thinky™ mixer for around 15 minutes to give the composite materials described in Examples 3a and 3b above.

The anode mixture (either 3a or 3b) was applied to a 10 μm thick copper foil (current collector) using a doctor-blade technique to give a 20-35 μm thick coating layer. The resulting electrodes were then allowed to dry.

### Cathode Preparation

The cathode material used in the test cells was a commercially available lithium MMO electrode material (e.g. Li₁₊ₓNi_{0.8}Co_{0.15}Al_{0.05}O₂) on a stainless steel current collector.

### Electrolyte

The electrolyte used in all cells was a 1.2M solution of lithium hexafluorophosphate dissolved in solvent comprising a mixture of ethylene carbonate and ethyl methyl carbonate (in the ratio 3:7 by volume) (82%), FEC (15 wt %) and VC (3 wt %). The electrolyte was also saturated with dissolved CO₂ gas before being placed in the cell.

### Cell Construction

“Swagelok” test cells were made as follows:
Anode and cathode discs of 12 mm diameter were prepared and dried over night under vacuum.
The anode disc was placed in a 2-electrode cell fabricated from Swagelok® fittings.
Two pieces of Tonen separator of diameter 12.8 mm and 16 um thick were placed over the anode disc.
40 μl of electrolyte was added to the cell.
The cathode disc was placed over the wetted separator to complete the cell.
A plunger of 12 mm diameter containing a spring was then placed over the cathode and finally the cell was hermetically sealed. The spring pressure maintained an intimate interface between the electrodes and the electrolyte.
The electrolyte was allowed to soak into the electrodes for 30 minutes.

### Example 5

### Cycling of Cells

Once assembled the cells were connected to an Arbin battery cycling rig, and tested on continuous charge and discharge cycles. The constant-current: constant voltage (CC-CV) test protocol used a capacity limit and an upper voltage limit on charge, and a lower voltage limit on discharge. The voltage limits were 4.3V and 3V respectively. The testing protocol ensured that the active anode material was not charged below an anode potential of 25 mV to avoid the formation of the crystalline phase Li₁₅Si₄ alloy. Cells were cycled by charging at C/25 for one cycle and discharging to between 1.0 and 0.005V. For the second and subsequent cycles, the cell was charged at C/5. A constant voltage of 5 mV was then applied for 2 hours or until the current drops to C/20. Finally the cell was discharged at C/5.

### Example 6

### EDX Analysis of Sodium Polyacrylate Coated Silicon Native Particles

An EDX analysis of silicon pillared particle was carried out. The results are set out below. Data was collected on X-max 80 from Oxford Instruments operating at an accelerated voltage of 20 KV and a working distance of 8 mm.

### RESULTS AND DISCUSSION

The charge/discharge capacity of cells including a composite material of Examples 3a and 3b is illustrated in FIG. 1. Line 1 illustrates how the capacity of a graphite-based composite electrode comprising uncoated silicon particles changes with number of cycles. Line 2 illustrates how the capacity of a graphite-based composite electrode comprising silicon particles coated with a 100% neutralised polyacrylic acid having a molecular weight of 3,000,000 changes with the number of charge discharge cycles. Line 3 illustrates how the capacity of a graphite-based composite electrode comprising silicon particles coated with a 100% neutralised polyacrylic acid having a molecular weight of 450,000 changes with the number of charge discharge cycles. From the results it can be seen that cells including a graphite based composite electrode including 100% neutralised sodium polyacrylate coated silicon particles exhibit superior capacity retention compared to cells comprising a graphite based composite electrode including uncoated silicon particles.

The EDX analysis of the coated native particle revealed a composition set out in table 1 below:

TABLE 1

| Element | Weight % | Atomic % |
|---|---|---|
| C K | 8.09 | 16.66 |
| O K | 3.49 | 5.4 |
| Na K | 0.23 | 0.25 |
| Si K | 88.19 | 77.69 |
| Total | 100 | |

1. An electrode for a lithium ion battery, the electrode comprising a current collector and a composite material applied to the surface of the current collector, wherein the composite material comprises an electroactive composite particle comprising:
a. a first particle component selected from the group comprising silicon, tin, germanium, gallium, lead, zinc, aluminium and bismuth and alloys and oxides thereof; and
b. a first polymeric coating
characterised in that the first polymeric coating adheres to the surface of the first particle component, is insoluble in N-methyl pyrrolidone (NMP), comprises one or more functional groups selected from a carboxylic acid and sulphonic acid functional group and covers at least 70% of the surface area of the first particle component.

2. An electrode according to claim 1, wherein the first polymeric coating comprises a carboxylic acid functional group.

3. An electrode according to claim 1 or claim 2, wherein the first polymeric coating is selected from the group of polymers comprising polyacrylic acid, carboxymethyl cellulose, alginic acid, polyethylene maleic anhydride and a vinylsulphonic acid polymer.

4. An electrode according to any one of the preceding claims, wherein the first polymeric coating is a metal ion salt of the functional group selected from the group comprising sodium, potassium, lithium, calcium and magnesium.

5. An electrode according to any one of the preceding claims, wherein the first particle component is silicon or an oxide thereof.

6. A electrode according to any one of the preceding claims, wherein the first particle component has a principle diameter in the range 100 nm to 100 μm.

7. A electrode according to any one of the preceding claims, wherein the first particle component has a minor diameter of at least 10 nm.

8. A electrode according to any one of the preceding claims, wherein the first particle component has an aspect ratio (ratio of principle diameter to minor diameter) in the range 1:1 to 100:1.

9. A electrode according to any one of the preceding claims, wherein the first particle component is selected from the group comprising native particles, pillared particles, porous particles, porous particle fragments, fractals, fibres, flakes, ribbons, tubes, fibre bundles, substrate particles and scaffold structures.

10. An electrode according to any one of the preceding claims, wherein the first particle component is selected from doped and undoped silicon.

11. An electrode according to any one of the preceding claims, wherein the first polymeric coating is porous.

12. An electrode according to any one of the preceding claims, wherein the first polymeric coating comprises a polymer having a molecular weight in the range 100,000 to 3,000,000.

13. An electrode according to any one of claims 4 to 12, wherein the first polymeric coating has a degree of salt formation in the range 60 to 100%.

14. An electrode according to any one of the preceding claims, wherein the thickness of the first polymeric coating is in the range 5 to 40 nm.

15. An electrode according to any one of the preceding claims, wherein the composite material further comprises a second active particle component and a polymeric binder.

16. An electrode according to claim 15, wherein the second active particle component comprises an electroactive material.

17. An electrode according to claim 15 or claim 16, wherein the second active particle comprises a second polymeric coating.

18. An electrode according to any one of the preceding claims, wherein the composite material comprises at least 50 wt % of an electroactive material comprising a first composite particle.

19. An electrode according to any one of claims 1 to 18, wherein the composite particle comprises at least 0.5 wt % of silicon.

20. An electrode according to any one of claims 15 to 19, wherein the composite material comprises at least 5 wt % of an electroactive carbon.

21. An electrode according to any one of claims 15 to 20, wherein the composite material further comprises a third conductive component.

22. An electrode according to any one of claims 15 to 21, wherein the composite material comprises a first particle component having a first polymeric coating, a second particle component and a polymeric binder, wherein the first particle component, first polymeric coating, second particle component and polymeric binder are present in a weight ratio in the range 9.0:0.05:88:2.95 to 9.0:0.5:88:2.5.

23. An electrode according to claim 21, wherein the composite material further includes a third conductive component, wherein the first particle component, first polymeric coating, second particle component, polymeric binder and third conductive component are present in a weight ratio in the range 9.0:0.05:85:2.95:3 to 9.0:0.5:85:2.5:3.

24. An electrode according to claim 17, wherein the second coating polymer has a molecular weight in the range 100,000 to 3,000,000.

25. An electrode according to any one of claims 17 to 24, wherein the second coating polymer comprises one or more functional groups selected from the group comprising a carboxylic acid and a sulphonic acid functional group or a sodium salt thereof.

26. An electrode according to any one of claims 17 to 25, wherein the second coating polymer is selected from the group comprising polyacrylic acid, polyethylene maleic anhydride, alginic acid, carboxymethylcellulose, a vinyl sulphonic acid polymer and the sodium salts thereof.

27. An electrode according to any one of claims 15 to 26, wherein the polymeric binder has a molecular weight in the range 100,000 to 3,000,000.

28. An electrode according to any one of claims 15 to 27, wherein the polymeric binder has a molecular weight of 700,000.

29. An electrode according to any one claims 15 to 28, wherein the polymeric binder is an ionically conductive polymer or an electrically conductive polymer.

30. An electrode according to any one of claims 15 to 29, wherein the polymeric binder has a Young's Modulus of at least of 0.3 GPa

31. An electrode according to any one of claims 15 to 30, wherein the polymeric binder is polyvinylidenefluoride (PVdF) or copolymers thereof.

32. An electrode according to claim 31, where the PVdF comprises from 0.7 to 1.0 wt % functional co-monomer groups within its structure.

33. An electrode according to claim 32, wherein the functional co-monomer groups comprise carboxylic acid monomer groups.

34. An electrode according to any one of claims 21 to 33, wherein the third conductive component is selected from the group comprising carbon black, lamp black, acetylene black, ketjen black, metal fibres and mixtures thereof.

35. An electrode according to any one of claims 15 to 34, wherein the second active particle component comprises graphite, hard carbon, graphene, carbon fibres, carbon nanotubes and mixtures thereof.

36. An electrode according to claim 35, wherein graphite is selected from the group comprising natural graphite, artificial graphite and meso-carbon micro-beads and a mixture thereof.

37. An electrode according to any one of claims 1 to 36, wherein the composite particle comprises a first particle component comprising silicon and a first polymeric coating selected from the group comprising sodium polyacrylate, sodium carboxymethylcellulose, sodium polyethylene maleic anhydride and sodium alginate.

38. An electrode according to any one of claims 15 to 37, wherein the second particle component comprises graphite and the binder comprises PVdF.

39. An electrode according to claim 38, wherein the PVdF comprises 0.7 to 1.0 wt % functional co-monomer groups within its structure.

40. A method of forming an electrode according to any one of claims 1 to 39, comprising the steps of forming a composite particle and depositing the composite particle onto the surface of a current collector, wherein formation of the composite particle comprising the steps of exposing a first particle component to a first coating polymer and isolating the coated particles.

41. A method according to claim 40, wherein the first coating polymer is provided in the form of a solution.

42. A method according to claim 40 or claim 41, which further includes the steps of drying the isolated coated particles.

43. A method according to any one of claim 41 or 42, wherein the first coating polymer solution has a concentration in the range 5 to 25 wt %.

44. A method according to any one of claims 41 to 43, wherein the first coating polymer solution comprises a polymer having a molecular weight in the range 100,000 to 3,000,000.

45. A method according to any one of claims 41 to 44, wherein the first coating polymer solution has a viscosity in the range 40 to 60 mPa·s.

46. A method according to any one of claims 41 to 45, wherein the first coating polymer solution comprises a first and second solvent component, wherein:
a. the volume ratio of the first solvent component to the second solvent component is in the range 19:2 to 1:1;
b. the first coating polymer is soluble in the first solvent component;
c. the first coating polymer is insoluble in the second solvent component;
d. the second solvent component has a higher boiling point than that of the first solvent component.

47. A method according to claim 46, wherein the second solvent component is removed thereby forming a composite particle comprising a porous coat.

48. A method according to any one of claims 40 to 47, wherein the coated particles are dried using one or more techniques selected from tray drying, spray drying, oven drying, fluidised bed drying and roll drying.

49. A method according to any one of claims 40 to 48, which further comprises the step of forming a slurry comprising the composite particle, a second active particle component and a polymeric binder in a liquid carrier, casting the slurry onto a current collector and drying the cast slurry.

50. A method according to claim 49, wherein the liquid carrier comprises a solution of the polymeric binder.

51. A cell comprising an electrode according to any one of claims 1 to 39.

52. A battery comprising one or more cells according to claim 51.

53. A device comprising a cell according to claim 51 or a battery according to claim 52.
